(19) United States
(12) Patent Application Publication
(10) Pub. No.: US 2023/0288736 A1
(43) Pub. Date: Sep. 14, 2023

(54) EDGE RESISTOR TO MITIGATE BUS BAR NONUNIFORMITY

(71) Applicant: GENTEX CORPORATION, Zeeland, MI (US)

(72) Inventors: Adam R. Heintzelman, Grand Rapids, MI (US); Xiaoxu Niu, Grand Rapids, MI (US); Kurtis L. Geerlings, Zeeland, MI (US)

(73) Assignee: GENTEX CORPORATION, Zeeland, MI (US)

(21) Appl. No.: 18/181,842

(22) Filed: Mar. 10, 2023

Related U.S. Application Data
(60) Provisional application No. 63/318,956, filed on Mar. 11, 2022.

(51) Int. Cl. G02F 1/01

(52) U.S. Cl. CPC G02F 1/0121; G02F 1/0107; G02F 2201/50

(57) ABSTRACT

An electro-optic device includes a first substrate having an electrically conductive coating disposed on a rear surface; a second substrate having a front surface opposed to the rear surface of the first substrate; a sealing member extending along a perimeter of the rear surface of first substrate and front surface of second substrate; a chamber defined by the first substrate, the second substrate, and sealing member; and an edge resistor disposed on along at least a portion of a perimeter area of at least one of rear surface of first substrate and front surface of second substrate. The edge resistor extends along a first portion of an electrically conductive coatings that covers a first portion of a length of the region, and a second portion of the length of the region is free from electrically conductive coating.

### CROSS REFERENCE TO RELATED APPLICATIONS

This application claims the benefit of and priority to U.S. Provisional Patent Application No. 63/318,956, filed on Mar. 11, 2022, entitled Edge Resistor to Mitigate Bus Bar Nonuniformity, the entire disclosure of which is hereby incorporated herein by reference.

### FIELD OF THE DISCLOSURE

This disclosure relates generally to devices and methods for controlling resistance of a bus bar, and in particular, to devices and methods for controlling resistance along the length of a bus bar.

### BACKGROUND

Currently, many electro-optic (EO) devices receive current through either a metallic clip-on bus bar or silver epoxy dispensed on and cured between the inner surfaces of an electro-optic cell. The metallic clip-on bus bar may be hidden behind a bezel along with the device seal. Likewise, the silver bus bar may be hidden behind a chrome ring along with the device seal. However, this may not be practical in some devices. Some devices cannot use a bezel or require a very narrow border. For example, in some devices, the chrome ring must be no more than two to three millimeters wide. In some devices, a very narrow cell spacing does not provide adequate room for a sufficient amount of silver to provide the desired conductance. This is especially true in devices having cell spacings of about 40 microns as compared to typical devices which may have cell spacing of 135 microns or more. In devices with very narrow cell spacing, the conductance of the bus bar may be too low to allow the device to function uniformly. The voltage drop along the bus bar may be too great, and consequently, the coloring density along the bus bar may exhibit an unacceptable gradient. This may be more pronounced on larger EO devices.

In some EO devices, it may be aesthetically desirable to reduce the size of or to eliminate the bus bar on the visible portion of the device. In some EO devices, it may be desirable to control the resistance from the bus bar to the device along its length to better control the darkening and clearing of the EO device, and to improve coloring uniformity. In some EO devices, it may be desirable to allow for the intentional design of darkening gradients for either aesthetic or functional purposes.

### SUMMARY

According to an aspect, an electro-optic (EO) device may comprise a first substrate having a first electrically conductive coating disposed on a rear surface of the first substrate; a second substrate having a front surface opposed to the rear surface of the first substrate, wherein a second electrically conductive coating is disposed on the front surface of the second substrate; a sealing member extending along a perimeter of the rear surface of first substrate and front surface of second substrate; a chamber defined by rear surface of first substrate, front surface of second substrate, and sealing member; and a patterned edge resistor disposed along at least a portion of a perimeter area of at least one of the rear surface of the first substrate and the front surface of the second substrate.

The patterned edge resistor may comprise at least two portions including a first portion having no electrically conductive coating and a second portion having an electrically conductive coating. The first portion may be disposed in a pattern and may be interspersed with the second portion. The first portion of the edge resistor may be disposed in a regular pattern. In some embodiments, the pattern may be a repeating pattern. In some embodiments, the pattern may vary along the length of the edge resistor.

The first portion may be disposed in a serpentine pattern and the second portion may surround the portion having no electrically conductive coating. The patterned edge resistor may restrict the flow of current.

The electro-optic device may further comprise a four-point contact scheme with two main current inputs and two sensing contact points.

According to another aspect, an electro-optic (EO) device may comprise a first substrate having a first electrically conductive coating disposed on a rear surface of the first substrate; a second substrate having a front surface opposed to the rear surface of the first substrate, wherein a second electrically conductive coating is disposed on the front surface of the second substrate; a sealing member extending along a perimeter of the rear surface of first substrate and front surface of second substrate; a chamber defined by the rear surface of the first substrate, the front surface of the second substrate, and the sealing member; and an edge resistor disposed along at least a portion of a perimeter area of at least one of the rear surface of the first substrate and the front surface of the second substrate. The edge resistor may be a bridge conductor comprising a non-conductive gap and a bridge comprising material having lower conductance than the first and second electrically conductive coatings. The bridge conductor may divide the electrically conductive coating into an inner portion and an outer portion.

The bridge may be in contact with both the outer portion and the inner portion of at least one of the first and second electrically conductive coatings. The bridge conductor may be tunable by adjusting a width of the non-conductive gap. The electro-optic device may further comprise a four-point contact scheme with two main current inputs and two sensing contact points.

According to another aspect, an electro-optic (EO) device may comprise a first substrate having a first electrically conductive coating disposed on a rear surface of the first substrate; a second substrate having a front surface opposed to the rear surface of the first substrate, wherein a second electrically conductive coating is disposed on the front surface of the second substrate; a sealing member extending along a perimeter of the rear surface of first substrate and front surface of second substrate; a chamber defined by rear surface of first substrate, front surface of second substrate, and sealing member; and an edge resistor comprising a multi-layer bus bar, the edge resistor disposed along at least a portion of a perimeter area of at least one of the rear surface of the first substrate and the front surface of the second substrate.

The multi-layer bus bar may comprise a first layer of high conductivity material disposed on and in contact with one of the first and second substrates, and a second layer of lower conductivity material. The resistance may be determined, at least in part, by the thickness of the respective layers. The electro-optic device may further comprise a four-point contact scheme with two main current inputs and two sensing contact points.

### BRIEF DESCRIPTION OF THE DRAWINGS

FIG. 1 illustrates a cross-sectional schematic representation of an electro-optic device in accordance with this disclosure;

FIG. 2 illustrates side view of a patterned edge resistor for an electro-optic device in accordance with this disclosure;

FIG. 3 illustrates a top view of a first pattern in the patterned edge resistor of FIG. 2;

FIG. 4 illustrates a top view of a second pattern in the patterned edge resistor of FIG. 2;

FIG. 5 illustrates a top view of a third pattern in the patterned edge resistor of FIG. 2;

FIG. 6 illustrates a side view of a bridged conductor edge resistor for an electro-optic device;

FIG. 7 illustrates a side view of a multi-layer edge resistor for an electro-optic device;

FIG. 8A illustrates a top view of a patterned edge resistor having a four-point contact scheme; and

FIG. 8B illustrates a diagram of a symbolic electro-optic element having a four-point contact scheme.

### DETAILED DESCRIPTION

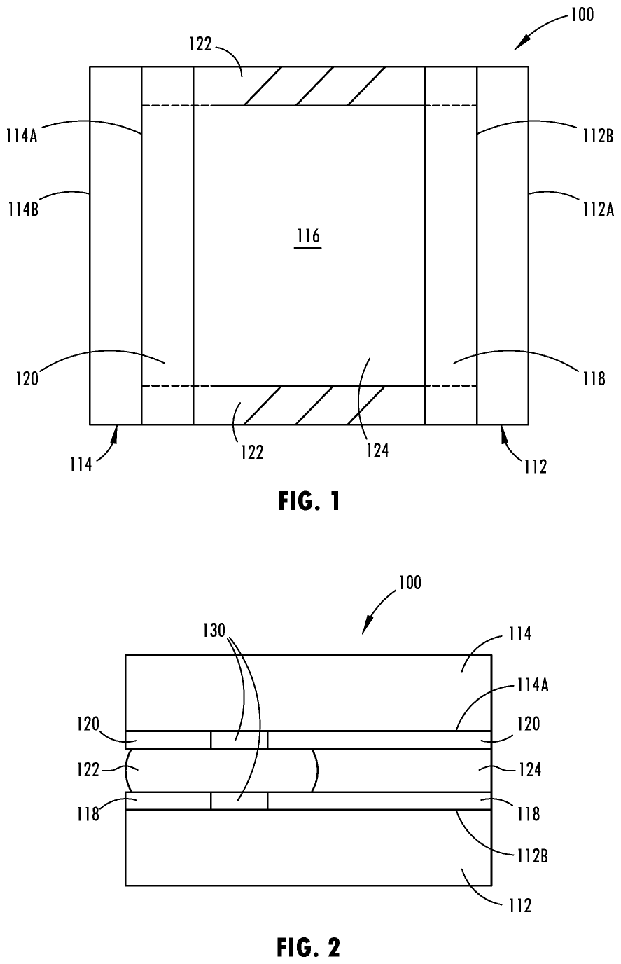

FIG. 1 shows a cross-sectional schematic representation of an electro-optic (EO) device 100. EO device 100 generally comprises a first substrate 112 having a front first surface 112A and a rear second surface 112B, and a second substrate 114 having a front third surface 114A and a rear fourth surface 114B. A sealing member 122 may extend between first and second substrates 112, 114 along at least a portion of a perimeter of EO device 100. A chamber 116 for containing electro-optic medium 124 may be defined by second surface 112B of first substrate 112, the opposed third surface 114A of second substrate 114, and sealing member 122. As shown in the figures, first substrate 112 may be closer to the viewer than second substrate 114.

One or more first layers of electrically conductive coatings 118 may be associated with second surface 112B of first substrate 112. These first layers of electrically conductive coatings 118 may serve as a first electrode for electro-optic device 100. Similarly, one or more second layers of electrically conductive coatings 120 may be associated with and disposed on third surface 114A of second substrate 114 and may operate as a second electrode for electro-optic device 100. Electrically conductive coatings 118, 120 may comprise material that: (a) is substantially transparent in the visible region of the electromagnetic spectrum; (b) bonds reasonably well to first substrate 112; (c) maintains this bond when associated with a sealing member 122; (d) is generally resistant to corrosion from materials contained within electro-optic device 100 or the atmosphere; and (e) exhibits minimal diffusion or specular reflectance as well as sufficient electrical conductance. Electrically conductive coatings 118, 120 may be fabricated from, for example, fluorine doped tin oxide (FTO), indium/tin oxide (ITO), doped zinc oxide or other materials known to those having ordinary skill in the art. First layers of electrically conductive coatings 118 may be the same as or different from second layers of electrically conductive coatings 120.

As shown in FIGS. 2-5, an edge resistor 130 may be disposed along at least a portion of a perimeter of EO device 100. The edge resistor 130 may be a patterned edge resistor 130, as shown in FIGS. 2-5. The patterned edge resistor 130 may be in contact with electrically conductive coating 118, 120 of electro-optic device 100. In some embodiments, patterned edge resistor 130 may be disposed on at least one of electrically conductive coating 118, 120. In some embodiments, patterned edge resistor 130 may be disposed within at least one of the layers of electrically conductive coating 118, 120. In some embodiments, patterned edge resistor 130 may extend along at least a portion of a perimeter area of at least one of first and second substrates 112, 114. Patterned edge resistor 130 may be disposed between sealing member 122 and the at least one of first and second substrates 112, 114, for example on second surface 112B of first substrate 112 or third surface 114A of second substrate 114.

Edge resistor 130 may extend over a region defined on at least one of second surface 112B of first substrate 112 and third surface 114A of second substrate 114 of electrically conductive coating 118, 120. Electrically conductive coating 118, 120 may cover a first portion of the region and a second portion of the region may be free from electrically conductive coating 118, 120. In some embodiments, patterned edge resistor 130 may be fabricated by specific removal of at least one of electrically conductive coatings 118, 120 at the edge of the electro-optic device 100 so as to generate a patterned edge resistor 130. Electrically conductive coating 118, 120 may be removed by laser ablation of electrically conductive coating 118, 120, or by other means known to those with skill in the art.

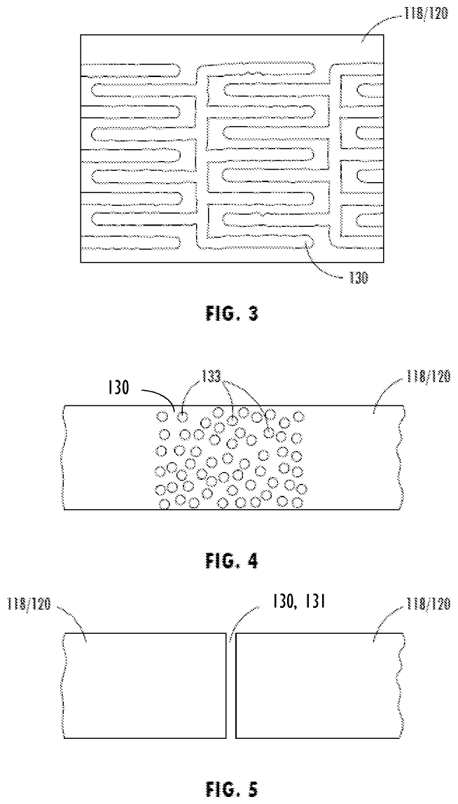

In some embodiments, the removal of electrically conductive coating 118, 120 may result in a longer route, or a “tortured path” arrangement, thereby resulting in a high resistance pathway. In some embodiments, electrically conductive coating 118, 120 may be removed in a pattern leaving the remaining electrically conductive coating 118, 120 disposed in, for example, a serpentine pattern, as shown in FIG. 3. In some embodiments, the removal of electrically conductive coating 118, 120 may result in a random arrangement of the remaining electrically conductive coating 118, 120 around a series of voids 133, such as shown in FIG. 4. In some embodiments, the removal of at least one electrically conductive coating 118, 120 may result in a restricted flow path 131 by narrowing the path through which the current may travel, as shown in FIG. 5. In these arrangements, and regardless of the configuration of patterned edge resistor 130, patterned edge resistor 130 may control the amount of current travelling through electrically conductive coating 118, 120 in the immediate region of the patterned edge resistor 130.

In some embodiments, the pattern of patterned edge resistor 130 may comprise a series of patterns, each of which may provide a different resistance. In some embodiments, the pattern may vary continually along the length of the patterned edge resistor 130. In some embodiments, the same pattern may extend along the length of the patterned edge resistor 130. In some embodiments, the pattern may be a regular, repeating pattern for at least a portion of the length of the patterned edge resistor 130. In some embodiments, the pattern may be irregular and may vary along the length of the patterned edge resistor 130.

In some embodiments, the pattern of patterned edge resistor 130 may vary along the length of the bus bar. This may create localized resistance variations. Different patterns or arrangements may be used to provide varying resistances, thereby allowing the voltages to vary along the length of bus bar in a desired manner. This may allow for “tuning” of the resistance, and that may allow for a more even distribution of current being delivered to EO device 100 along bus bar. With proper design, this can be used to create voltages at the interface of EO medium 124 and bus bar that do not drop at all or drop very little along the length of the bus bar. Additionally, an arbitrary voltage may be designed along the length to match the requirements of the transmission profile. This may allow for a more even distribution of current being delivered to EO device 100.

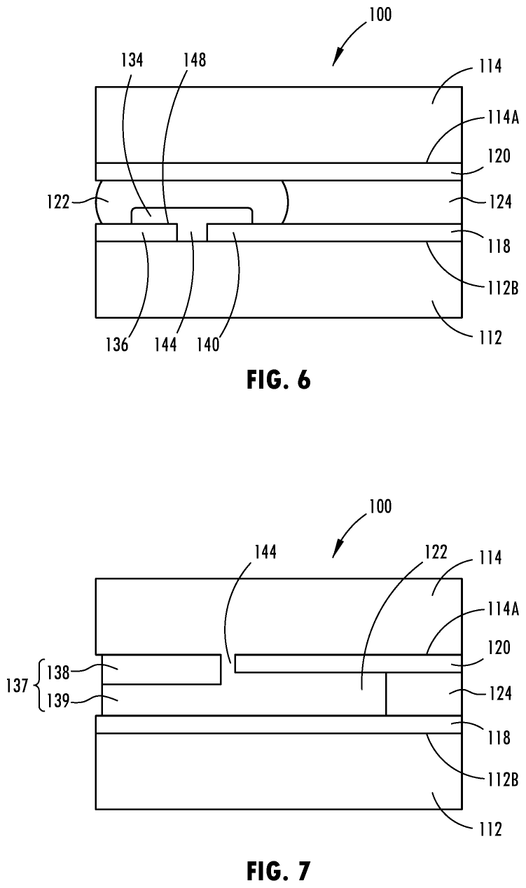

In some embodiments, as shown in FIG. 6, the edge resistor 130 may comprise a bridged conductor 134. In the bridged conductor 134, a portion of at least one of electrically conductive coating 118, 120 may be removed from the corresponding one of first and second substrates 112, 114 along a length of at least a portion of sealing member 122, leaving an outer portion 136 of electrically conductive coating 118, 120, an inner portion 140 of electrically conductive coating 118, 120, and a non-conductive gap 144 in electrically conductive coating 118, 120 extending therebetween. In some embodiments, non-conductive gap 144 may be generally rectangular in shape. In some embodiments, non-conductive gap 144 may be in the shape of an elongated trapezoid with one end narrower than the other. In some embodiments, non-conductive gap 144 may be irregular in shape. Non-conductive gap 144 may extend along at least a portion of the perimeter of EO device 100, leaving outer portion 136 of the at least one electrically conductive coating 118, 120 separated from inner portion 140 of electrically conductive coating 118, 120.

In some embodiments, a bridge 148 comprising a material having a lower conductance than the electrically conductive coatings 118, 120 may be disposed over non-conductive gap 144 in such a way as to contact both outer portion 136 of the at least one electrically conductive coating 118, 120 and inner portion 140 of the at least one electrically conductive coating 118, 120. (As used herein, the term conductivity relates to the inherent electrically properties of the bulk material, while the term conductance also takes into consideration the geometry or form of the bulk material.)

In some embodiments, bridge 148 may extend along at least half of the length of non-conductive gap 144. Bridge 148 may extend across non-conductive gap 144, linking outer portion 136 of electrically conductive coating 118, 120 to inner portion 140 of electrically conductive coating 118, 120. In some embodiments, bridge 148 may be “tuned” by adjusting at least one of the material used in bridge 148 and the size of the non-conductive gap 144. Tuning bridge 148 may provide the required resistance for the application, thereby allowing for a more even distribution of current being delivered to EO device 100.

As an example, a 1 mm wide non-conductive gap 144 may be laser ablated in electrically conductive coating 118, 120, and a bridge 148 of a low-conductive material may extend over non-conductive gap 144. The low-conductivity material of bridge 148 may comprise, for example, a low-conductivity carbon ink or an ultra-thin metallic semi-conductive coating. Resistance along the length of non-conductive gap 144 may be varied by at least one of varying the thickness of non-conductive gap 144 and using different lower-conductivity coatings along the length of non-conductive gap 144. The width of non-conductive gap 144 may be adjusted along the length of non-conductive gap 144 to provide the desired resistance at differing points along the length. I.e., a first section of non-conductive gap 144 may have a first width and a second section of non-conductive gap 144 may have a second width different than the first width. Sealing member 122 may be in contact with both inner and outer portions 136 of electrically conductive coating 118, 120 on both sides of bridge 148, and may extend over exposed portions of bridge 148.

In some embodiments as shown in FIG. 7, a multi-layer bus bar 137 may be applied to at least one surface 112B, 114A of electro-optic device 100. A first layer 138 of multi-layer bus bar 137 may comprise a high conductivity material and may be disposed directly on and in contact with one of first and second substrates 112, 114. A second layer 139 of multi-layer bus bar 137 may comprise a low conductivity material and may be disposed on first layer 138 of high conductivity material. The thickness of the respective layers of material may be controlled to provide the desired resistance.

In some embodiments, multi-layer bus bar 137 may be disposed along at least a portion of perimeter of EO device 100. Sealing member 122 may be disposed adjacent to multi-layer bus bar 137, in such a way as to be positioned between multi-layer bus bar 137 and chamber 116. A non-conductive gap 144 in electrically conductive coating 118, 120 may extend along the high conductivity material of first layer 138 of multi-layer bus bar 137. In some embodiments, electrically conductive coating 118, 120 on third surface 114A of second substrate 114 may extend from chamber 116 to sealing member 122, but not extend to first layer 138 of multi-layer bus bar 137, leaving a non-conductive gap 144 between electrically conductive coating 118, 120 and multi-layer bus bar 137.

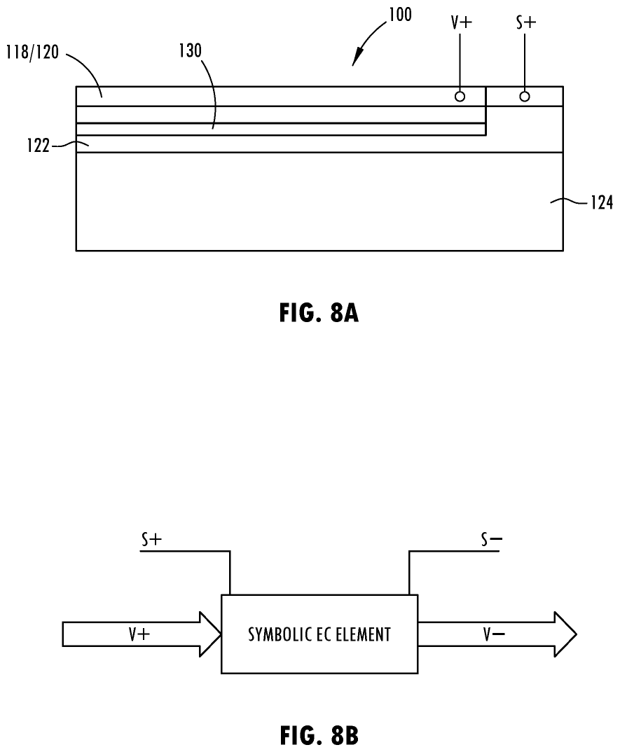

In some embodiments, a four-point contact scheme may be used to control voltage delivered to EO device 100 as shown in FIGS. 8A and 8B. The four-point contact scheme may allow variations in resistance paths without unduly affecting EO device 100 performance. In the four-point contact scheme, a voltage higher than required for driving the desired electrochromic reaction may be supplied to EO device 100 through main current inputs V+ and V−. V+ and V− may be in electrical communication with EO device 100 and with a controller 160.

Voltage sensing contact points S+ and S− may disposed on electrically conductive coating 118, 120 and may be in electrical communication with both EO device 100 and controller 160. The voltage supplied to V+ and V− may be high enough to drive voltage sensing contact points S+ and S− to a desired voltage. For example, for a desired voltage of 1.2 V at voltage sensing contact points S+ and S−, the main current inputs to EO device 100 V+ and V− may be set at 4 V. Voltage sensing points S+ and S− may be in contact with EO medium 124. Thus, EO medium 124 may only see a voltage of 1.2 V.

Separate wires may connect each of the four contact points S+, S−, V+, and V−, to controller 160. Controller 160 may be configured to adjust the voltage applied to the voltage terminals in order to get the desired voltage at the sensing points.

This may become more important as the temperatures stray from room temperature. Without sensing probes, it would be possible to force too much power through EO device 100 at low temperatures, causing irreversible damage. Alternatively, at high temperatures, without sensing contact points, EO device 100 may end up being driven at voltages that do not deliver enough current to overcome the more rapid reactions in the center of the cell, thus leading to a higher device transmission than is required. Feedback from the sensing contact points in both of these circumstances will allow for the proper amount of current or voltage to be delivered to achieve the best performance.

Additionally, upon clearing, 4-point sensing scheme may also drive the cell to achieve zero volts at the sensing contact points. This may mean that the cell is momentarily driven at a negative bias. This has the effect of clearing the cell faster than the cell would clear with a zero voltage. In some embodiments, sensing contact points S+ and S− of the 4-point sensing scheme may be set to any desired voltage within range of the EC cell, thereby allowing the maintenance of infinitely variable dimmability.

The arrangements disclosed herein may allow for the fabrication of an EO device 100 either without a bus bar or with a very narrow bus bar. In some embodiments, one of patterned edge resistor 130 and bridge 148 may function as the bus bar. In some embodiments, a bus bar having sufficiently high conductance may be constructed in a location in which there is insufficient space for a traditional bus bar.

Since the arrangements disclosed herein may allow for greater control over the applied voltage delivered to an electro-optic device 100, darkening may be more uniform. The great control over the applied voltage may further allow for non-uniform darkening of an EO device 100 if desired. For example, voltage may be applied to allow the upper portion of a window to darken more than the lower portion of the window, thereby acting as a shade. In some embodiments, the voltage may be controlled to produce a sharp transition between a darker portion of the window and a lighter portion of the window. In some embodiments, the voltage may be controlled to produce a gradual transition between a darker portion of the window and a lighter portion.

A method of controlling the darkening and clearing of an EO device 100 may comprise providing a patterned edge resistor along an edge of EO device and providing a four-point contact scheme including main current inputs V+ and V−, voltage sensing contact points S+ and S−, and a controller. A current may be applied to the patterned edge resistor. The controller may adjust the voltage applied to the voltage terminals.

The above description is considered that of the preferred embodiments only. Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims as interpreted according to the principles of patent law, including the doctrine of equivalents. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

In this document, relational terms, such as first and second, top and bottom, front and back, left and right, vertical, horizontal, and the like, are used solely to distinguish one entity or action from another entity or action, without necessarily requiring or implying any actual such relationship, order, or number of such entities or actions. These terms are not meant to limit the element which they describe, as the various elements may be oriented differently in various applications. Furthermore, it is to be understood that the device may assume various orientations and step sequences, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

It will be understood that any described processes or steps within described processes may be combined with other disclosed processes or steps to form structures within the scope of the present disclosure. The exemplary processes disclosed herein are for illustrative purposes and are not to be construed as limiting. It is also to be understood that variations and modifications can be made on the aforementioned methods without departing from the concepts of the present disclosure, and further it is to be understood that such concepts are intended to be covered by the following claims unless these claims by their language expressly state otherwise.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within at least one of 2% of each other, 5% of each other, and 10% of each other.

1. An electro-optic (EO) device comprising:
a first substrate having a first electrically conductive coating disposed on a rear surface of the first substrate;
a second substrate having a front surface opposed to the rear surface of the first substrate, wherein a second electrically conductive coating is disposed on the front surface of the second substrate;
a sealing member extending along a perimeter of the rear surface of first substrate and front surface of second substrate;
a chamber defined by rear surface of first substrate, front surface of second substrate, and sealing member; and
a patterned edge resistor disposed along at least a portion of a perimeter area of at least one of the first and the second electrically conductive coatings of the electro-optic device.

2. The electro-optic device of claim 1, wherein the patterned edge resistor comprises at least two portions including a first portion having no electrically conductive coating and a second portion having an electrically conductive coating.

3. The electro-optic device of claim 2, wherein the first portion is disposed in a pattern and is interspersed with the second portion.

4. The electro-optic device of claim 3, wherein the first portion of the edge resistor is disposed in a regular pattern.

5. The electro-optic device of claim 4, wherein the pattern is a repeating pattern.

6. The electro-optic device of claim 4, wherein the pattern varies along length of the edge resistor.

7. The electro-optic device of claim 3, wherein the first portion is disposed in a serpentine pattern and the second portion surrounds the first portion.

8. The electro-optic device of claim 1, wherein the patterned edge resistor restricts the flow of current.

9. The electro-optic device of claim 1 further comprising a four-point contact scheme with two main current inputs and two sensing contact points.

10. An electro-optic (EO) device comprising:
a first substrate having a first electrically conductive coating disposed on a rear surface of the first substrate;
a second substrate having a front surface opposed to the rear surface of the first substrate, wherein a second electrically conductive coating is disposed on the front surface of the second substrate;
a sealing member extending along a perimeter of the rear surface of first substrate and front surface of second substrate;
a chamber defined by the rear surface of the first substrate, the front surface of the second substrate, and the sealing member; and
an edge resistor disposed along at least a portion of a perimeter area of at least one of the rear surface of the first substrate and the front surface of the second substrate;
wherein the edge resistor is a bridge conductor comprising:
a non-conductive gap; and
a bridge comprising material having lower conductance than the first and second electrically conductive coatings;
wherein the bridge conductor divides the electrically conductive coating into an inner portion and an outer portion.

11. The electro-optic device of claim 10, wherein the bridge is in contact with both the outer portion and the inner portion of at least one of the first and second electrically conductive coatings.

12. The electro-optic device of claim 10, wherein the bridge conductor is tunable by adjusting a width of the non-conductive gap.

13. The electro-optic device of claim 10 further comprising a four-point contact scheme with two main current inputs and two sensing contact points.

14. An electro-optic (EO) device comprising:
a first substrate having a first electrically conductive coating disposed on a rear surface of the first substrate;
a second substrate having a front surface opposed to the rear surface of the first substrate, wherein a second electrically conductive coating is disposed on the front surface of the second substrate;
a sealing member extending along a perimeter of the rear surface of first substrate and front surface of second substrate;
a chamber defined by rear surface of first substrate, front surface of second substrate, and sealing member; and
an edge resistor comprising a multi-layer bus bar, the edge resistor disposed along at least a portion of a perimeter area of at least one of the rear surface of the first substrate and the front surface of the second substrate.

15. The electro-optic device of claim 14, wherein the multi-layer bus bar comprises a first layer of high conductivity material disposed on and in contact with one of the first and second substrates, and a second layer of lower conductivity material; and wherein the resistance is determined, at least in part, by the thickness of the respective layers.

16. The electro-optic device of claim 14 further comprising a four-point contact scheme with two main current inputs and two sensing contact points.
